(19) United States
(12) Patent Application Publication
(10) Pub. No.: US 2009/0135855 A1
(43) Pub. Date: May 28, 2009

(54) Apparatus for automatically synchronizing setting information of wireless device

(76) Inventor: Sung-Kyu Kim, Seoul (KR)

Correspondence Address: VENABLE LLP, P.O. BOX 34385, WASHINGTON, DC, 20043-9998, US

(21) Appl. No.: 11/990,845

(22) PCT Filed: Aug. 22, 2006
(86) PCT No.: PCT/KR2006/003291

§ 371 Date: Feb. 22, 2008

(30) Foreign Application Priority Data
Aug. 22, 2005 (KR) 10-2005-0076943

(51) Int. Cl. H04J 3/06

(52) U.S. Cl. 370/503

(57) ABSTRACT

Provided is a portable device having an automatic setting information synchronizing function for a two-way radio communication. The portable device includes a radio communication unit for transmitting/receiving data to/from an external fixing device via a two-way radio communication, an input/output unit for providing an input/output interface, a synchronizing unit for receiving setting information from the external fixing device, and a central processing unit for controlling the radio communication unit, to thereby receive the setting information through the synchronizing unit upon connection with the external fixing device and to transmit/receive various data inputted/outputted through the input/output unit based on the received setting information via the two-way radio communication upon release of connection with the external fixing device.

### TECHNICAL FIELD

The present invention relates to an apparatus and method for automatically synchronizing setting information for a two-way radio communication. In particular, the invention is directed to an apparatus and method which are capable of establishing synchronization between a portable device (e.g., wireless microphone) and a fixing device without setting the portable device separately. The synchronization can be established by connecting the portable device to the fixing device and automatically delivering various kinds of setting information having communication information (e.g., communication codes for transmission/reception of the both devices), input/output interface information, and device identification information (e.g., inherent number), required for the two-way radio communication therebetween.

### BACKGROUND ART

A fixing device used herein refers to a device that is connected to each electronic equipment such as an amp (audio amp), a karaoke system, a video device (Divx device), TV, an Internet terminal, or the like by wire/wireless, or embedded therein, and controls an operation of each portable device by changing a program, operation information, etc., upon a change of each electronic equipment.

Further, the fixing device can also serve as a charger for each portable device in parallel with the above-mentioned function.

Meanwhile, a portable device used herein is defined as an auxiliary input/output device of the fixing device, and gives/takes input/output data (e.g., microphone input) to/from the fixing device via a two-way radio communication (1:1 or 1:N).

More concretely, the portable device accepts from a fixing device setting information (including communication information, input/output interface information and device identification information) required for a two-way radio communication with the fixing device, and then operates depending on the accepted setting information. In other words, the portable device communicates with the fixing device according to the setting information received from the fixing device. Specifically, the portable device provides an input/output interface to a user, and allows the user to manipulate an electronic equipment connected to the fixing device, such as instructing an accompaniment start of a karaoke system.

The following is a detailed explanation of one example of a wireless microphone system that operates in a one-way.

FIG. 1 is a block diagram illustrating a configuration of a conventional wireless microphone system.

The conventional wireless microphone system shown in FIG. 1 includes a microphone 1, a transmitter 2 for transmitting data received via the microphone 1 by wireless, and a receiver 3 connected to an amp 4 or embedded therein for delivering the data (microphone input) received from the transmitter 2 by wireless to the amp 4. An integrated device of the microphone 1 and the transmitter 2, and the receiver 3 can be communicated in a two-way radio fashion of 1:1 or 1:N form.

At this time, communication ways mainly used for the transmitter 2 to transfer the data (e.g., microphone input) received via the microphone 1 to the receiver 3 are ways of transmitting an analog signal via an analog communication, a digital signal via an analog communication, and a digital signal via a digital communication.

In case of transmitting an analog signal via an analog communication, the signal is continuously transmitted by occupying 100% of a designated channel, which transmits plenty of data. However, it is not possible to share the communication channel, recovery damaged received data, and control transmission flow, thereby increasing power consumption, having an effect such as confusion on other equipments, and lowering security due to receipt of signal by virtue of other equipments.

Further, in case of transmitting a digital signal via an analog communication, information required for error detection and recovery of received data can be additionally transmitted, but an amount of data to be transmitted is increased. This makes channel bandwidth enlarged and also the number of available communication channels smaller.

On the contrary, in case of transmitting a digital signal via a digital communication, data can be compressed and then transmitted, and one communication channel can be shared by plural equipments or plural portable devices, thereby using the channel more efficiently. However, in this case, it is required to separately set an inherent communication code (communication code for transmission and reception) and a password assigned to each equipment, except for communication channel.

More specifically, in order to transmit/receive data via a two-way digital communication, there is a need to synchronously set various kinds of communication information such as communication channel and modulation method, communication code (communication code for transmission and reception), encryption mode, communication output, and spare communication channel and modulation method against confusions between both equipments, respectively.

By the way, such a method sets various kinds of information required for the two-way digital communication in the both equipments respectively, but synchronizing the information and changing the same from time to time is inconvenient to the user in many ways.

In particular, the use of the communication code (communication code for transmission and reception) and password with a greater number can reduce possibility of overlapping (it is possible to distinguish one system from another system having a same communication frequency and modulation method) compared with that with a smaller number, and also prevent wiretapping due to difficulty of decryption. However, it is quite difficult for the user to set the greater number manually.

Namely, in the above-described prior art, in case where the portable device and the fixing device transmit data via the two-way digital (wireless) communication (for example, in case where an integrated device of a microphone and a transmitter transmits/receives data to/from a receiver in a wireless microphone system), it is significantly difficult to perform various kinds of setting of information required for the communication simultaneously in the both equipments and synchronize them in users' position of the both equipments.

### DISCLOSURE

### Technical Problem

It is, therefore, an object of the present invention to provide an apparatus and method which are capable of allowing a two-way radio communication between a portable device (e.g., a wireless microphone) and a fixing device, without setting the portable device separately. This communication can be accomplished by establishing synchronization between the two devices by connecting the portable device to the fixing device (e.g., for charging) and automatically delivering various kinds of setting information, previously stored in the fixing device, required for the two-way radio communication therebetween, to the portable device.

In other words, the invention provides an apparatus and method which are capable of readily establishing synchronization between a portable device (e.g., a wireless microphone) and a fixing device, without setting the portable device separately, by connecting the two devices and automatically delivering various kinds of setting information required for a two-way radio communication between the both devices. These setting information, for example, contain communication information (e.g., communication code and password for transmission/reception of the both ends, communication channel and modulation method, data length, communication output, spare communication channel and modulation method, etc.), input/output interface information, and device identification information (e.g., an inherent number assigned to each electronic equipment).

### Technical Solution

In accordance with one aspect of the present invention, there is provided a portable device having an automatic setting information synchronizing function for a two-way radio communication, including: a radio communication unit for transmitting/receiving data to/from an external fixing device via a two-way radio communication; an input/output unit for providing an input/output interface; a synchronizing unit for receiving setting information from the external fixing device; and a central processing unit for controlling the radio communication unit, to thereby receive the setting information through the synchronizing unit upon connection with the external fixing device and to transmit/receive various data inputted/outputted through the input/output unit based on the received setting information via the two-way radio communication upon release of connection with the external fixing device.

In accordance with another aspect of the present invention, there is provided a fixing device having an automatic setting information synchronizing function for a two-way radio communication, including: a radio communication unit for transmitting/receiving data to/from each external portable device via a two-way radio communication; a synchronizing unit for delivering setting information to each external portable device; and a central processing unit for controlling the radio communication unit, to thereby transmit the setting information to each external portable device through the synchronizing unit upon connection with each external portable device and to transmit/receive various data based on the transmitted setting information via the two-way radio communication upon release of connection with each portable device.

In accordance with still another aspect of the present invention, there is provided a method for automatic synchronization of setting information for a two-way radio communication in a portable device, the method including the steps of: receiving setting information from an external fixing device upon connection with the external fixing device; and transmitting/receiving data to/from the external fixing device based on the setting information via the two-way radio communication upon release of connection with the external fixing device.

In accordance with a further another aspect of the present invention, there is provided a method for automatic synchronization of setting information for a two-way radio communication in a fixing device, the method including the steps of: transmitting setting information to a portable device upon connection with the portable device; and transmitting/receiving data to/from the portable device based on the setting information via the two-way radio communication upon release of connection with the portable device.

The other objectives and advantages of the invention will be understood by the following description and will also be appreciated by the embodiments of the invention more clearly. Further, the objectives and advantages of the invention will readily be seen that they can be realized by the means and its combination specified in the claims.

### ADVANTAGEOUS EFFECTS

As described above and will be mentioned below, the present invention has an advantage in that it automatically synchronizes setting information required for a two-way radio communication between each portable device and a fixing device by connecting the two devices and synchronizing them conveniently without setting each portable device separately, thereby allowing the two-way radio communication.

In other words, the invention allows the synchronization of setting information for the two-way radio communication to be automatically established by connection of each portable device and the fixing device and thus can communicate data by using a communication scheme with more excellent performance in terms of security and stability.

Furthermore, the present invention causes the fixing device and each portable device to be readily updated simultaneously by virtue of the automatic synchronization of setting information. As a result, the invention can more flexibly cope with changes of various kinds of electronic equipments connected to the fixing device.

### DESCRIPTION OF DRAWINGS

The above and other objects and features of the present invention will become apparent from the following description of the preferred embodiments given in conjunction with the accompanying drawings, in which:

FIG. 1 is a block diagram illustrating a configuration of a conventional wireless microphone system;

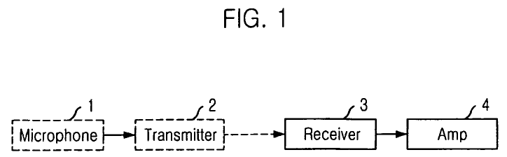

FIG. 2 is a block diagram illustrating a configuration of an apparatus for automatically synchronizing setting information for a two-way radio communication in accordance with a preferred embodiment of the present invention;

FIG. 3 shows a block diagram illustrating a configuration of the radio microphone system to which the present invention is applied;

FIG. 4 illustrate a flowchart for describing an automatic setting information synchronizing method for a two-way radio communication in a fixing device in accordance with a preferred embodiment of the present invention;

FIG. 5 is a flowchart for describing an automatic setting information synchronizing method for a two-way radio communication in a portable device in accordance with a preferred embodiment of the present invention; and

FIGS. 6 and 7 are views for describing the setting information synchronization performed simultaneously with charging of the portable device in the wireless microphone system shown in FIG. 3.

### BEST MODE FOR THE INVENTION

The above-mentioned objectives, features, and advantages will be more apparent by the following detailed description in association with the accompanying drawings; and thus, the invention will be readily conceived by those skilled in the art to which the invention pertains. Further, in the following description, well-known arts will not be described in detail if it seems that they could obscure the invention in unnecessary detail. Hereinafter, preferred embodiments of the present invention will be set forth in detail with reference to the accompanying drawings.

The present invention allows various kinds of setting information required for synchronization between both devices for a two-way radio communication therebetween to be automatically transferred, to thereby establish synchronization between the both devices without setting each portable device separately. Here, each portable device is connected to the fixing device to automatically accept various kinds of setting information required for the two-way radio communication with the fixing device.

For example, it is possible to charge each portable device by connecting it to the fixing device for its charging and at the same time deliver various kinds of setting information, thus establishing synchronization between the both devices (the portable device and fixing device) according to a new setting value at all times.

Here, the setting information required for the two-way radio communication may contain various kinds of information for a plurality of communication equipments to share one frequency, for example, a communication code (communication code for transmission and reception) and a password. Accordingly, it is allowable to do a two-way radio communication with enhanced security and stability.

The following is a description of an example where each portable device is connected to a fixing device (installed at a charger holder) for charging to thereby synchronize setting information.

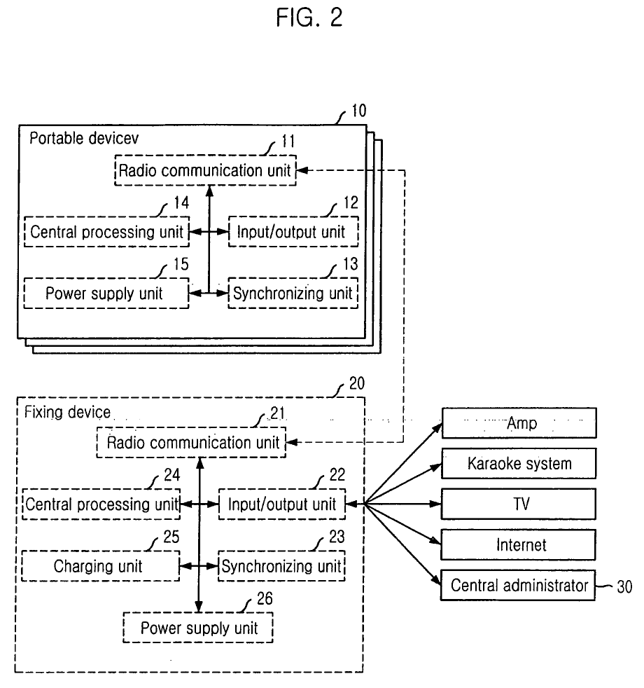

FIG. 2 is a block diagram illustrating a configuration of an apparatus for automatically synchronizing setting information for a two-way radio communication in accordance with a preferred embodiment of the present invention.

Here is a detailed explanation of components of each of a portable device and a fixing device.

As shown in FIG. 2, a portable device 10 having an automatic setting information synchronizing function for a two-way radio communication according to the invention includes a radio communication unit 11 for transmitting/receiving various kinds of data (input/output data) to/from a fixing device 20 by wireless, an input/output unit 12 for providing an input/output interface to a user, a synchronizing unit 13 for receiving setting information from the fixing device 20 and delivering it to a central processing unit 14, the central processing unit 14 for controlling an operation of each of the above components, to thereby transmit/receive various kinds of input/output data through the radio communication unit 11 based on the setting information, and a power supply unit 15.

Here, the portable device 10 functions as an auxiliary input/output device of the fixing device 20 connected to an arbitrary electronic equipment (e.g., a karaoke system or an amp).

For example, if the portable device 10 is a wireless microphone and the electronic equipment connected to the fixing device 20 is the karaoke system, the portable device 10 outputs data, e.g., audio data, song list, song words, etc., received from the fixing device 20 through the input/output unit 12. Further, it transmits data, e.g., microphone input, button input (e.g., song reservation and accompaniment start instruction), etc., received from the user through the input/output unit 12 to the fixing device 20 so that it can forward them to the karaoke system connected thereto. At this time, the transmission/reception of data between the portable device 10 and the fixing device 20 is performed via the two-way radio communication. And, for the two-way radio communication, synchronization (of setting information) between the portable device 10 and the fixing device 20 should be established.

Explaining each component of the portable device 10 more concretely, the radio communication unit 11 transmits/receives various kinds of data to/from the fixing device 20 via a two-way radio communication under the control of the central processing unit 14. Here, the central processing unit 14 controls the radio communication unit 11 to give/take data to/from the fixing device 20 depending on the synchronized setting information. The setting information contains communication information for the two-way radio communication, which will be described later.

The input/output unit 12 provides an input/output interface to the user by the control of the central processing unit 14. In other words, it outputs the data (for example, audio data) received from the fixing device 20 to the user, and receives various kinds of data (for example, microphone input) to be sent to the fixing device 20 from the user. The output of data can be made by means of a display unit, a speaker, an earphone, or the like and the input of data can be done by a keypad, a touch screen, a joystick, a keyboard, or the like.

The synchronizing unit 13, which is a separate communication unit from the radio communication unit 11, receives setting information from a synchronizing unit 23 of the fixing device 20 by connecting the portable device 10 to the fixing device 20 for charging.

To be more specific, when the portable device 10 is connected to the fixing device 20, it delivers its own setting information to the fixing device 20, thereby judging whether or not synchronization is established. Namely, setting information stored in the fixing device 20 is compared with setting information stored in the portable device 10 to judge whether the two information are identical to each other (that is, synchronization is established). If the synchronization was not established, the synchronizing unit 13 receives the latest setting information from the synchronizing unit 13 of the fixing device 20. Of course, if the synchronization was made, it accepts no separate setting information.

At this time, a transmission/reception path of the setting information may be a serial input/output (SIO) communication, a parallel input/output (PIO communication, and so on. Here, the transmission/reception of setting information is automatically performed by making connection between the two devices (the portable device and fixing device).

The central processing unit 14 is in charge of the control of each component and also allows the synchronizing unit 13 to receive various kinds of setting information from the synchronizing unit 23 of the fixing device 20 by connecting the portable device 10 to the fixing device 20 for charging (that is, by installing the portable device at a charger holder prepared at the fixing device). That is, setting information previously stored for the two-way radio communication is substituted (synchronized) with a setting value newly received through the synchronizing unit 13.

At this time, the setting information contains communication information such as communication code and password for transmission/reception of the both ends, communication channel and modulation method, data length, communication output, spare communication channel and modulation method, etc., input/output interface information, and device identification information (e.g., an inherent number assigned to each electronic equipment). Although the communication code and password for transmission/reception may have a same value, it is preferable to have different values (usually, greater numerals) for security and stability. And, the device identification information is inherent information given to each of a plurality of electronic equipments, the fixing device and the portable device and is used by a central administrator 30 for wholly administering the plurality of equipments, which will be described later.

Further, upon release of connection between the portable device 10 and the fixing device 20 (upon detachment of the portable device from the charger holder prepared at the fixing device), the central processing unit 14 periodically transmits/receives signal to/from the fixing device 20 via the radio communication unit 11, thus preventing disconnection. That is, it makes the two devices operated after changing to a radio mode. And, the central processing unit 14 may control them to do continuous transmission/reception of data by moving to a spare communication channel based on the previously stored setting information upon issuance of communication interruption or confusions. At this time, when connection is not made even by using the spare communication channel, the central processing unit releases establishment with the fixing device 20 and then outputs a warning signal (e.g., a text message or an alarm). In this case, synchronization should be newly established for a following data transmission/reception. That is, it notifies the user that the auxiliary input/output function of the portable device 10 with respect to the fixing device 20 was inactivated.

Meanwhile, the fixing device 20 having an automatic setting information synchronizing function for a two-way radio communication according to the invention includes a radio communication unit 21 for transmitting/receiving various kinds of data to/from each portable device 10 by wireless, a connection unit 22 for transmitting/receiving data to/from an electronic equipment (e.g., an amp or karaoke system) by wire/wireless, a synchronizing unit 23 for transmitting previously stored setting information to the portable device 10 upon connection with it, and a central processing unit 24 for controlling each of the components, to thereby transmit/receive various kinds of data to/from each portable device 10 through the radio communication unit 21 based on the previously synchronized setting information, wherein the data received from the portable device 10 is delivered to the electronic equipment (e.g., an amp or karaoke system) via the connection unit 22, and the data received from the electronic equipment is sent to the portable device 10, a charging unit 25, and a power supply unit 26.

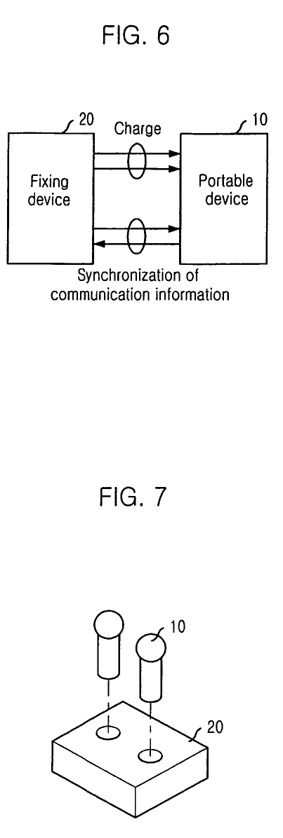

The fixing device 20 is provided with a charger holder capable of charging each portable device 10, which will be described later with reference to FIGS. 6 and 7.

The fixing device 20 may give/take data to/from each portable device 10 via a two-way radio communication. At this time, the fixing device 20 and each portable device 10 synchronize inherent communication codes contained in the setting information to thereby prevent other device (e.g., other portable device) from intervening in communication between the two devices. That is, if the communication codes are the same (correctly, if the communication codes for transmission/reception assigned to the two devices are correct ones), the process of decrypting password of transmission/reception data is carried out.

Below are details of each of the components of the fixing device 20. First of all, the radio communication unit 21 transmits/receives various kinds of data to/from the radio communication unit 11 each portable unit 10 by wireless. In other words, it transmits data received from the electronic equipment (e.g., an amp, karaoke system, or TV) connected to the connection unit 22 to the portable device 10, and delivers data received from the portable device 10 to the electronic equipment via the connection unit 22.

For example, if the portable device 10 is a wireless microphone and the electronic equipment connected to the connection device 22 is the karaoke system, the radio communication unit 21 sends audio data, song list, song words, etc., received from the karaoke system through the connection unit 22 under the control of the central processing unit 24. Further, it transmits data, e.g., microphone input, button input (e.g., song reservation and accompaniment start instruction), etc., received from the portable device 10 to the karaoke system through the connection unit 22. Here, the wireless microphone may include various kinds of input/output units such as a separate input unit (e.g., keyboard), a display unit (e.g., LCD), an audio output unit (e.g., speaker), and so on.

The connection unit 22 is a unit used for giving/receiving data to/from each electronic equipment (e.g., an amp, karaoke system, TV) by wire/wireless by the control of the central processing unit 24. Of course, the fixing device 20 may be embodied within the electronic equipment.

The synchronizing unit 23, which is a separate communication unit from the radio communication unit 21 and the connection unit 22, transmits the previously stored setting information to the synchronizing unit 13 of the arbitrary portable device 10 by connecting it to the fixing device 20. Here, the setting information contains communication information, input/output interface information, and device identification information (e.g., inherent number assigned to each electronic equipment), required for the two-way radio communication, as described above.

The following is a detailed transmission procedure of the setting information. First of all, the synchronizing unit 23 receives the setting information stored in the portable device 10 from the synchronizing unit 13 of the portable device 10 connected to the fixing device 20, and delivers it to the central processing unit 24, to thereby judge whether or not synchronization was established. Then, if the synchronization was not established, the setting information previously stored in the fixing device 20 is sent to the synchronizing unit 13 of the portable device 10 under the control of the central processing device 24, thereby substituting (synchronizing) the setting information. At this time, the transmission/reception path of the setting information may be a serial input/output (SIO) communication, a parallel input/output (PIO) communication, and the like.

The central processing unit 24 controls the synchronizing unit 23 upon connection of each portable device 10 and the fixing device 20 (that is, upon installation of the portable device at a charger holder prepared at the fixing device, to thereby send the previously stored setting information (the setting information for the two-way radio communication) to the portable device 10. At this time, the previously stored setting information is newly stored setting information by input from outside (user) or by operation of program.

Further, upon release of connection between the portable device 10 and the fixing device 20 (upon detachment of the portable device from the charger holder prepared at the fixing device), the central processing unit 24 operates in a radio mode. That is, it periodically transmits/receives signal to/from the portable device 10 via the radio communication unit 21, thus preventing disconnection. And the central processing unit 24 delivers data (e.g., microphone data or button data) received from the portable device 10 through the radio communication unit 21 to electronic equipment via the connection unit 22, and transmits data (e.g., audio data, song list, or song words) received from the electric equipment via the connection unit 22 to the portable device 10 via the radio communication unit 21.

At this time, the data transmission/reception between the radio communication unit 21 and the radio communication unit 11 of the portable device 10 is performed depending on the previously synchronized setting information. For example, each component is controlled to transmit/receive data by using the previously synchronized communication channel and modulation method. At this time, in case where the communication interruption or confusions is occurred, it may try transmission/reception of data by moving to a spare communication channel. If this is also failed, the central processing unit releases the establishment with the portable device 10 (thus synchronization should be newly established for following data transmission/reception), and then outputs a warning signal through an input/output unit incorporated therein (not shown, for example a display unit). Alternatively, it may forward a warning output request signal to the central administrator 30 via the connection unit 22 so that the central administrator 30 can output the warning signal.

Meanwhile, the fixing device 20 collects information about a power, charging, fault, operation status, etc. of at least portable device 10 (e.g., wireless microphone) and each fixing device (including the device 20 itself) as well as the electric equipment (e.g., an amp or karaoke system) connected to the device 20 itself, and provides them to the central administrator 30 that is in charge of the control of each equipment.

Further, if data received from the portable device 10 is, for example, microphone input, the fixing device 20 may process it (by echo, reverb, volume adjustment, mixing, etc.) and then output processed data to the electric equipment (e.g., karaoke system). If howling is generated by checking the microphone input, it may be possible to decrease the output intensity and cause no howling phenomenon.

In other words, the fixing device 20 as described above uses the portable device 10 except for the input/output unit (not shown) basically embedded therein as the auxiliary input/output unit. Specifically, the fixing device 20 triggers the portable device 10 to perform relatively simple functions (i.e., input/output function and data transmission/reception function using the two-way radio communication), but directly performs various kinds of process functions and collection function of status (e.g., fault status and operation status) information of each equipment. Accordingly, the weight and cost as well as the power consumption can be reduced by simplifying the structure of the portable device 10. For the above purpose, it is preferable that the fixing device 20 includes various data such as font, image and menu required for the input/output unit basically embedded in the portable device 10 or in the device 20 itself, and information required for communication with various kinds of equipments (electronic equipments such as each portable device and karaoke system).

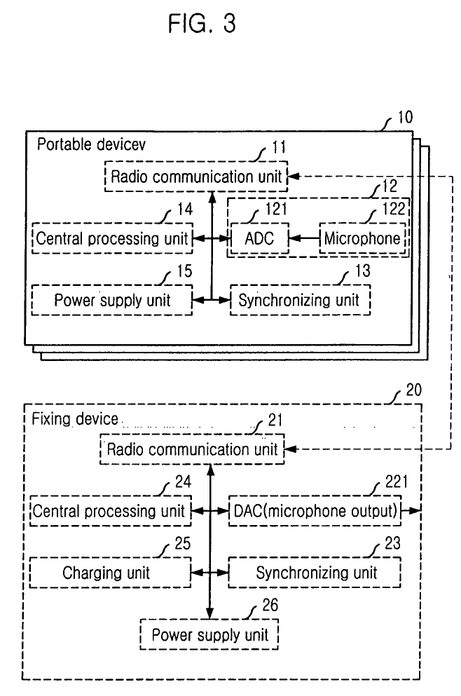

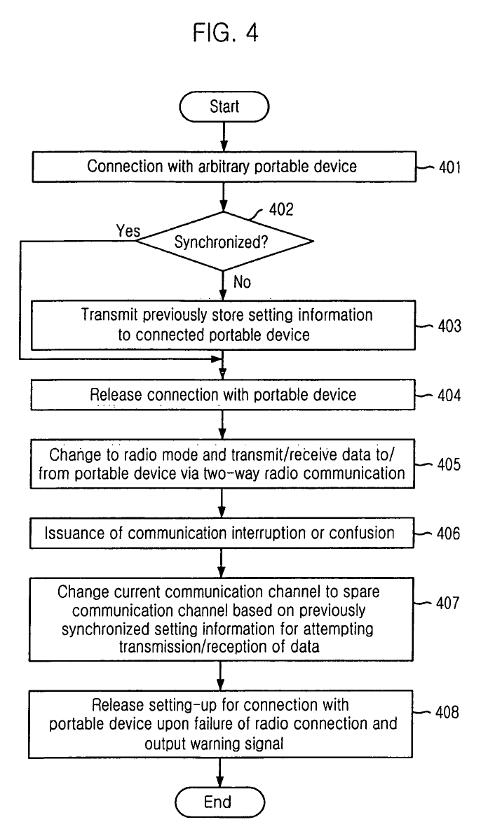

Now, a more detailed operation procedure of each of the portable device 10 and the fixing device 20 as mentioned above will be given with reference to FIGS. 3 and 4.

Here is a detailed description of an example where the present invention is applied to a radio microphone system with reference to FIG. 3.

FIG. 3 shows a block diagram illustrating a configuration of the radio microphone system to which the present invention is applied.

The radio microphone system shown in FIG. 3 includes a portable device 10 for providing an input/output interface to a user and a fixing device 20 for transmitting/receiving data using the portable device 10 as an auxiliary input/output unit and transmitting/receiving data via a two-way radio communication. At this time, the fixing device 20 may be connected to an amp (audio amp), a karaoke system, and so on by wire/wireless or be incorporated therein.

First of all, the portable device 10 includes a radio communication unit 11 for transmitting/receiving data to/from the fixing device 20 via a two-way radio communication, an input/output unit 12 for receiving a user's voice (analog) and converting it into a digital signal, a synchronizing unit 13 for receiving setting information from the fixing device 20 upon connection therewith, a central processing unit 14 for controlling the radio communication unit 11 so that it can transmit/receive data through the radio communication unit 11 based on the setting information received through the synchronizing unit 13 and transmits the digital data received/converted by the input/output unit 12 to the fixing device 20, and a power supply unit 15.

At this time, the input/output unit 12 is provided with a microphone 122 for taking a user's voice (analog) and an ADC 121 for converting an analog signal received from the microphone 122 into a digital signal. Here, the input/output unit 12 may further include other units (e.g., a display unit) associated with the input/output, in addition to the microphone 122 and the ADC 121. In this case, there may be an additional function of outputting data (which may be song list and song words if the karaoke equipment is connected to the fixing device) received from the fixing unit 20 through the radio communication unit 11 to the user.

Further, the fixing device 20 includes a radio communication unit 21 for transmitting/receiving data to/from the portable device 10 via a two-way radio communication, a DAC 221 for converting a digital signal into an analog signal, a synchronizing unit 23 for transmitting previously stored setting information to the portable device 10 upon connection therewith, and a central processing unit 24 for controlling the radio communication unit 21 so that it can deliver the setting information to the portable device 10 upon connection of the portable device 10 and the fixing device 20 and transmit/receive data to/from the portable device 10 by wireless based on the setting information, wherein the DAC 221 converts the data received through the radio communication unit 21 into an analog signal and outputs it to an electronic equipment (not shown, for example karaoke system), a charging unit 25, and a power supply unit 26.

More specifically, the DAC (microphone output) 221 converts data (e.g., user's voice) received through the portable device 10 that is the auxiliary input/output unit into a digital signal under the control of the central processing unit 24, and then outputs it to the electric equipment (e.g., karaoke system) connected to the DAC 221 (microphone output). Further, there may be an additional unit for communicating with the electric equipment by wire/wireless, in addition to the DAC (microphone output) 221.

Meanwhile, the fixing device 20 may be synchronized with a plurality of portable devices 10, respectively, thereby establishing communication therebetween by wireless.

FIG. 4 illustrate a flowchart for describing an automatic setting information synchronizing method for a two-way radio communication in the fixing device 20 in accordance with a preferred embodiment of the present invention.

First of all, when the arbitrary portable device 10 is connected to the fixing device 20 (401), it is judged whether or not the fixing device 20 is synchronized with the portable device 10 (402). That is, upon connection of the new portable device 10, the central processing unit 24 judges whether or not it shares the same (coincident) setting information with the portable device 10. At this time, the transmission/reception of data for confirmation of whether to share the same setting information can be performed by the synchronizing unit 23.

If it is judged at step 402 that the synchronization is established, the process of the invention goes to step 404.

Meanwhile, if it is judged at step 402 that the synchronization is not established, previously stored setting information is sent to the connected portable device 10 (403). In other words, the central processing unit 24 controls the synchronizing unit 23 to transmit the setting information to the synchronizing unit 13 of the portable device 10. At this time, the setting information contains communication, input/output interface information, and device identification information for supporting the two-way radio communication, which are previously set information by input from the outside (user).

Thereafter, when the fixing device 20 releases the connection with the portable device 10 (404), the operation mode is changed to a radio mode (405).

Namely, the central processing unit 24 controls the radio communication unit 21 to transmit/receive various data to/from the portable device 10 via the two-way radio communication. To be more specific, it delivers data (e.g., microphone input) received from the portable device 10 through the radio communication unit 21 to the electronic equipment (e.g., karaoke system) connected through the connection unit 22, and transmits data (e.g., song list, song words) from the electric equipment to the portable device 10 through the radio communication unit 21.

At this time, the transmission/reception of various data is carried out based on the communication information (communication codes and passwords for transmission/reception of the both ends, communication channel and modulation method, data length, communication output, spare communication channel and modulation method, etc.) contained in the setting information via the two-way radio communication.

Next; upon issuance of communication interruption or confusions (406), the current communication channel is changed to a spare communication channel depending on the previously synchronized setting information and then the transmission/reception of data to/from the portable device 10 is attempted (407).

In succession, when radio connection is failed even by the spare communication channel, the setting-up for connection with the portable device 10 is released and a warning signal is outputted (408). And information on the setting-up release from the portable device 10 is announced to the central administrator 30 connected via the connection unit 22. It will be of course obvious to those skilled in the art that the two-way radio communication can be interrupted upon receipt of a request for the setting-up release from the portable device 10 through the input/output unit basically embedded therein.

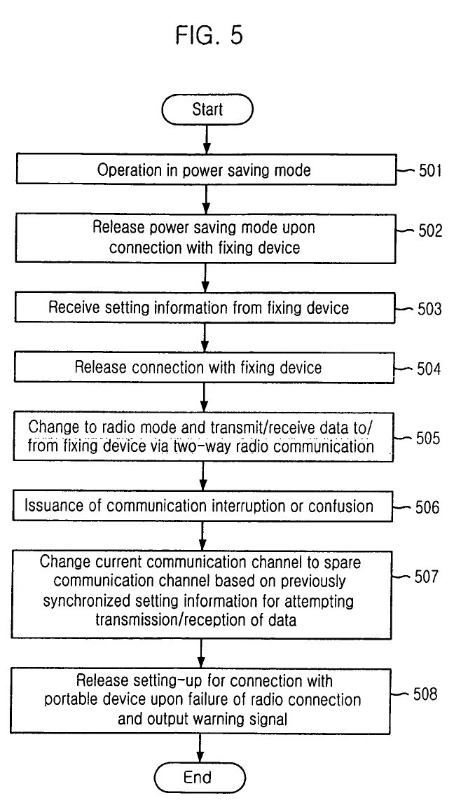

FIG. 5 is a flowchart for describing an automatic setting information synchronizing method for a two-way radio communication in the portable device 10 in accordance with a preferred embodiment of the present invention.

First, it is assumed that the portable device 10 is being operated in a power saving mode (501).

Thereafter, when the portable device 10 is connected to the fixing unit 20, the power saving mode is released (502). And it receives the setting information required for the two-way radio communication from the fixing unit 20 (503). In other words, the central processing unit 14 releases the power saving mode upon connection of the fixing device 20 and the fixing device 20, and receives the setting information having communication information, input/output interface information and device identification information through the synchronizing unit 13. At this time, a radio communication test may be conducted separately after performing synchronization of setting information (here, the radio communication test is performed under the state that the portable device 10 is connected to the fixing device 20.

And then, upon release of connection with the fixing device 20 (504), it changes an operation mode to a radio mode (505). That is, the central processing unit 14 sends the data received from the input/output unit 12 to the fixing device 20 via the radio communication unit 11, and outputs the data received from the fixing device 20 to the user via the input/output unit 12. At this time, the transmission/reception of various data is carried out based on the communication information (communication codes and passwords for transmission/reception of the both ends, communication channel and modulation method, data length, communication output, spare communication channel and modulation method, etc.) contained in the setting information via the two-way radio communication.

Next, upon issuance of communication interruption or confusions (506), the current communication channel is changed to a spare communication channel depending on the previously synchronized setting information and then the transmission/reception of data to/from the fixing device 20 is attempted (507).

Subsequently, when radio connection is failed even by the spare communication channel, the setting-up for connection with the fixing device 20 is released and a warning signal is outputted (508). Of course, it will be obvious to those skilled in the art that the two-way radio communication can be halted upon receipt of a request for the setting-up release from the fixing device 20 from the user through the input/output unit 12.

FIGS. 6 and 7 are views for describing the setting information synchronization of the portable device 10 and the fixing device 20 performed simultaneously with charging of the portable device 10 in the wireless microphone system shown in FIG. 3.

As shown in FIG. 6, the setting information synchronization of the fixing device 20 and the portable device 10 may be performed simultaneously with charging of the portable device 10.

In other words, the fixing device 20 may be provided with a charger holder (not shown) for the portable device 10 so that the portable device 10 is charged by its installation on the charger holder and at the same time the setting information is delivered via the synchronizing units 13 and 23 prepared at each of the two devices. In this case, the synchronization of setting information is made simultaneously with charging, and therefore, the following works for the two-way radio communication can be progressed in a time-effective manner.

Further, shown in FIG. 7 is a process of installing the portable device 10 at the fixing device 20 for the charge and synchronization of setting information if the portable device 10 is a wireless microphone. As depicted in FIG. 7, the fixing device 20 may be connected with one or more portable devices 10.

Namely, the fixing device 20 can communicate data with the one or more portable devices 10 via the two-way radio communication. For the above purpose, it will be apparent to those skilled in the art that the synchronization of setting information between the fixing device 20 and each portable device 10 should be established separately. For example, it may be possible to prevent other equipments from intervening between the two devices during communication by setting communication codes (communication codes for transmission/reception) and passwords differently for each portable device 10.

The method of the present invention as mentioned above may be implemented by a software program that is stored in a computer-readable storage medium such as CD-ROM, RAM, ROM, floppy disk, hard disk, optical magnetic disk, or the like. This process may be readily carried out by those skilled in the art; and therefore, details of thereof are omitted here.

While the present invention has been described with respect to certain preferred embodiments, it will be apparent to those skilled in the art that various changes and modifications may be made without departing from the scope of the invention as defined in the following claims.

1. A portable device having an automatic setting information synchronizing function for a two-way radio communication, comprising:
a radio communication means for transmitting/receiving data to/from an external fixing device via a two-way radio communication;
an input/output means for providing an input/output interface;
a synchronizing means for receiving setting information from the external fixing device; and
a central processing means for controlling the radio communication means, to thereby receive the setting information through the synchronizing means upon connection with the external fixing device and to transmit/receive various data inputted/outputted through the input/output means based on the received setting information via the two-way radio communication upon release of connection with the external fixing device.

2. The portable device as recited in claim 1, wherein the setting information includes communication information required for the two-way radio communication.

3. The portable device as recited in claim 2, wherein the communication information includes at least one of communication code and password, communication channel and modulation method, data length, communication output, spare communication channel and modulation method.

4. The portable device as recited in claim 1, wherein upon disconnection of the radio connection during the transmission/reception of data to/from the fixing device via the two-way radio communication, the central processing means controls each of the meanses to thereby change a current communication channel to a spare communication channel for attempting transmission/reception of data.

5. The portable device as recited in claim 1, wherein upon failure of the radio connection, the central processing means further performs a function of releasing setting-up for connection with the fixing device by using the received setting information to prevent the transmission/reception of data.

6. The portable device as recited in claim 1, wherein when the portable device is connected to the fixing device for charging, the central processing means controls the synchronizing means to receive the setting information from the fixing device.

7. A fixing device having an automatic setting information synchronizing function for a two-way radio communication, comprising:
a radio communication means for transmitting/receiving data to/from each external portable device via a two-way radio communication;
a synchronizing means for delivering setting information to said each external portable device; and
a central processing means for controlling the radio communication means, to thereby transmit the setting information to said each external portable device through the synchronizing means upon connection with said each external portable device and to transmit/receive various data based on the transmitted setting information via the two-way radio communication upon release of connection with said each portable device.

8. The fixing device as recited in claim 7, wherein the setting information includes communication information required for the two-way radio communication.

9. The fixing device as recited in claim 8, wherein the communication information includes at least one of communication code and password, communication channel and modulation method, data length, communication output, spare communication channel and modulation method.

10. The fixing device as recited in claim 7, wherein upon disconnection of the radio connection during the transmission/reception of data to/from said each portable device via the two-way radio communication, the central processing means controls each of the means to thereby change a current communication channel to a spare communication channel for attempting transmission/reception of data.

11. The fixing device as recited in claim 7, wherein upon failure of the radio connection, the central processing means further performs a function of releasing setting-up for connection with said each portable device that failed the radio connection by using the transmitted setting information to prevent the transmission/reception of data.

12. The fixing device as recited in claim 7, wherein when a specific portable device among a plurality of portable devices is connected to the fixing device for charging, the central processing means controls the synchronizing means to transmit the setting information to the specific portable device.

13. A method for automatic synchronization of setting information for a two-way radio communication in a portable device, the method comprising the steps of:
receiving setting information from an external fixing device upon connection with the external fixing device; and
transmitting/receiving data to/from the external fixing device based on the setting information via the two-way radio communication upon release of connection with the external fixing device.

14. The method as recited in claim 13, wherein the setting information includes communication information required for the two-way radio communication.

15. The method as recited in claim 14, wherein the communication information includes at least one of communication code and password, communication channel and modulation method, data length, communication output, spare communication channel and modulation method.

16. The method as recited in claim 13, wherein upon disconnection of the radio connection, said transmitting/receiving step changes a current communication channel to a spare communication channel for attempting transmission/reception of data.

17. The method as recited in claim 13, further comprising the step of, upon failure of the radio connection, releasing setting-up for connection with the fixing device by using the received setting information to prevent the transmission/reception of data.

18. The method as recited in claim 13, wherein when the portable device is connected to the fixing device for charging, said receiving step receives the setting information from the fixing device.

19. A method for automatic synchronization of setting information for a two-way radio communication in a fixing device, the method comprising the steps of:
transmitting setting information to a portable device upon connection with the portable device; and
transmitting/receiving data to/from the portable device based on the setting information via the two-way radio communication upon release of connection with the portable device.

20. The method as recited in claim 19, wherein the setting information includes communication information required for the two-way radio communication.

21. The method as recited in claim 20, wherein the communication information includes at least one of communication code and password, communication channel and modulation method, data length, communication output, spare communication channel and modulation method.

22. The method as recited in claim 19, wherein upon disconnection of the radio connection, said transmitting/receiving step changes a current communication channel to a spare communication channel for attempting transmission/reception of data.

23. The method as recited in claim 19, further comprising the step of, upon failure of the radio connection, releasing setting-up for connection with the portable device by using the transmitted setting information to prevent the transmission and reception of data.

24. The method as recited in claim 19, wherein when the portable device is connected to the fixing device for charging, said transmitting step transmits the setting information to the portable device.
